(19) United States
(12) Patent Application Publication
(10) Pub. No.: US 2010/0012641 A1
(43) Pub. Date: Jan. 21, 2010

(54) Vehicle heating system

(76) Inventors: Jurgen Hetzler, Offenbach (DE); Norbert Ernst, Billigheim (DE)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 12/460,019

(22) Filed: Jul. 10, 2009

(30) Foreign Application Priority Data
Jul. 15, 2008 (DE) 10 2008 033 140.6

(51) Int. Cl. B60H 1/22

(52) U.S. Cl. 219/202

(57) ABSTRACT

The description relates to a vehicle heating system having a plurality of heating devices (10) which each having at least one heating element (12) arranged between two contact plates (11), a plurality of heat transfer devices (2a, 2b, 2c) through which air to be heated can flow and to which at least one of the heating devices (10) is attached, and a holder (4) which combines the heat transfer devices (2a, 2b, 2c) to the heating devices (10) attached thereto to form an assembly. According to the invention the heat transfer devices (2a, 2b, 2c) each include at least one heating device receptacle in which one of the heating devices (10) is arranged.

The invention relates to a vehicle heating system comprising a plurality of heating devices and heat transfer devices. Such a system is, for example, known from EP 1 780 061 A1.

Where the known heating device is concerned, PTC elements are glued between contact plates which are arranged in parallel and are bonded to corrugated ribs as heat transfer devices. The assemblies thus formed are each provided with a holding frame and are then combined to form a heating unit. A plurality of such heating units which are arranged in series as seen in flow direction are combined with a further frame and an attachment to form a vehicle heating system.

It is an object of the present invention to show a way of simplifying the manufacture of a vehicle heating system.

### SUMMARY OF THE INVENTION

This problem is solved by a vehicle heating system comprising the features presented in Claim 1. Advantageous further developments of the invention are the subject matter of the subordinate claims.

In a vehicle heating system according to the invention, the heat transfer devices are provided with heating device receptacles in which the heating devices are arranged. For example, the heating device receptacles can be formed as open channels, into which the heating devices and/or their components are inserted. Such channels can, for example, have a U-shaped cross-section. Preferably, however, the heating device receptacles have openings into which the heating devices are inserted.

Easy and cost-effective manufacture can be realized by means of heating device receptacles provided on the heat transfer devices. That is to say that, in this manner, the attachment of the heating devices to the heat transfer device can be achieved without much of an effort. For example, the heating devices can be held in the heating device receptacles in a positive and/or non-positive manner. In particular, the heat transfer devices can advantageously be used to hold the individual elements of the heating devices, i.e. their contact plates with heating elements arranged therebetween, together. Thereby, the structure of the heating devices can be simplified; it is, in particular, possible to do without complex soldering or glueing of the contact plates of the heating devices to the heating elements. Furthermore, the heating devices can be locked in position in the heating device receptacles of the heat transfer devices in a clamping manner, with the result that manufacture can be simplified in this respect as well.

Advantageously, the heat transfer devices and the heating devices attached thereto are combined by means of a holder to form an assembly, so that a vehicle heating system according to the invention can be perfectly handled.

Preferably, the heating devices of neighboring heat transfer devices are arranged in a staggered manner in relation to the flow direction. In this manner, a particularly efficient heat transfer to air flowing through the heat transfer devices can be achieved. If heat transfer devices of equal shape are used, a staggered arrangement of the heating devices can be achieved by arranging neighboring heat transfer devices differently in relation to the flow direction. For example, neighboring heat transfer devices can be arranged in a laterally staggered manner in relation to the flow direction. A further possibility of a staggered arrangement of the heating devices is to arrange neighboring heat transfer devices with reverse orientation in relation to the flow direction, that is to say such that the air flows towards the front side of one heat transfer device whereas another heat transfer device arranged downstream thereof faces the air flow with its rear side. A further possibility is to exchange the connection sides of an asymmetric heat transfer device, that is to say to install at least one of the heat transfer devices upside down. Preferably, the heat transfer devices combined to form an assembly have equally long front sides, with the holder being placed on said front sides.

Preferably, the heat transfer devices comprise tubes into the openings of which the heating devices are inserted. In this manner, the heat transfer devices can be thermally coupled to the heating devices in a particularly efficient manner, especially if the tubes are compressed after the heating devices have been inserted.

An advantageous further development of the invention provides that the heat transfer devices are extruded profiles comprising holes through which air can flow in transverse direction in relation to the extrusion direction. The extrusion direction is the same as the longitudinal direction of the heating devices and their contact plates. In an extruded profile, suitable holes can, for example, be made without much effort by means of a punching process. The use of extruded profiles as heat transfer devices allows cost-effective manufacture because laborious assembly of the heat transfer device from a large number of single components can be avoided. In contrast to traditional heat exchangers which are built of sheet-metal fins, it is, therefore, possible to achieve significant simplification. Furthermore, extruded profiles can be made as tubes extending in extrusion direction without any additional effort. The heating devices can be inserted in the openings of said tubes.

The extruded profiles that are used as heat transfer devices can be obtained by cutting a (long) extruded profile to length such that the individual heat exchangers are formed in an equal manner.

The extruded profiles preferably used as heat transfer devices are, preferably, provided with a base plate in which the holes for air flow are provided. Fins for heat transfer can extend from such a base plate on one side or either side thereof. Preferably, the extruded profile has only one single plate. However, it is also possible to use extruded profiles with two plates which are arranged in parallel and which are connected via heat transfer fins or intermediate walls arranged therebetween.

Preferably, each heat transfer device of a vehicle heating system according to the invention comprises a plurality of heating device receptacles. It is, however, also possible to provide a heat transfer device with only one single heating device receptacle. Heat transfer devices of a vehicle heating system according to the invention can be arranged in parallel rows and a plurality of such rows can be arranged in series as seen in flow direction.

Another advantageous further development of the invention provides that a plurality of contact rails extend in parallel in transverse direction in relation to the flow direction, wherein both contact plates of each heating device are each connected to one of two neighboring contact rails. These contact rails can be alternately connected to the positive and negative pole, respectively, of a voltage source. This alternation in flow direction results in a simple and clear circuit arrangement.

Another advantageous further development of the invention provides that the two contact plates of each heating device are electrically isolated from the heat transfer devices. In this manner, increased safety can be achieved which is, in particular, advantageous for higher supply voltages of, for example, 400 volts. That is to say that, by electrically isolating both contact plates from the heat transfer devices, the heat transfer devices can be connected to ground potential. Thereby the heat transfer devices are prevented from being energized by an electrical potential in the event of a defect.

The contact plates of the heating devices may each carry a positioning frame which forms at least one receptacle for a heating element. In this manner, the assembly of the heating devices can be simplified since the heating elements, which are preferably rectangular PTC elements, are just placed into the receptacles provided to this end and are subsequently covered with a second contact plate which likewise carries a positioning frame which is, preferably, shaped in an equal manner. Thereby, the number of different parts for the manufacture of the vehicle heating system can be reduced, with the result that costs are also reduced.

In order to allow pre-assembly of the positioning frames with the contact plates, the positioning frames can extend around edges of the contact plates, so that the contact plates are held by the positioning frame both on a front side facing the heating elements and on a rear side. Suitable positioning frames can be made of polymer ceramic or plastic and can be clicked into place on the contact plates, pushed onto the contact plates, or injection-molded around the contact plates.

Advantageously, PTC elements, two positioning frames and two contact plates can be pre-assembled to form a unit.

Preferably, the positioning frames leave a rear side of the contact plates open, said rear side facing away from the heating elements. This rear side of the contact plates is, preferably, covered with an electrically insulating lining, for example with a strip made of Kapton film or an electrically insulating ceramic material. In order to obtain a particularly good insulation, it is also possible to place a plurality of strips made of the same or of a different material one on top of the other.

An electric insulation of the contact plates can also be achieved by means of the material of a positioning frame covering the rear side, for example polyamide. However, injection-moldable materials usually are to disadvantage in that they always cause a considerable thermal insulation as well. By electrically insulating the contact plates by means of a separate lining, the electric insulation can be combined with an advantageously higher thermal conductivity and, thus, enhanced thermal coupling of the heating device to the heat transfer device.

The PTC elements can be held by the positioning frame in a friction-locked manner or in a positive manner. For example, the PTC elements can be clamped in the receptacles of the positioning frames. To this end, the positioning frames are, preferably, provided with clamping noses.

Preferably, the positioning frames enclose the heating elements in a fluid-tight manner. Particularly if the contact plates and the heating elements are not arranged in tubes or the tubes are not fluid-tight, the positioning frames can advantageously prevent any contact between the fluid to be heated and the heating elements. For example, the two positioning frames of a heating device can rest against each other in a sealing manner. A seal may be arranged between the insulating frames.

### BRIEF DESCRIPTION OF THE DRAWINGS

Further details and advantages of the invention will be illustrated by means of an exemplary embodiment with reference being made to the enclosed drawings. In the drawings,

FIG. 1 shows an exemplary embodiment of a vehicle heating system according to the invention;

FIG. 2 shows the heat transfer devices of the exemplary embodiment shown in FIG. 1, along with the heating devices and contact rails attached to said heat transfer devices;

FIG. 3 shows a detail of a lateral view of FIG. 2;

FIG. 4 shows an exploded view of a heating device of the vehicle heating system shown;

FIG. 5 shows the holder of the exemplary embodiment shown in FIG. 1; and

FIG. 6 shows the holder shown in FIG. 5, including heat transfer devices attached thereto.

### DETAILED DESCRIPTION

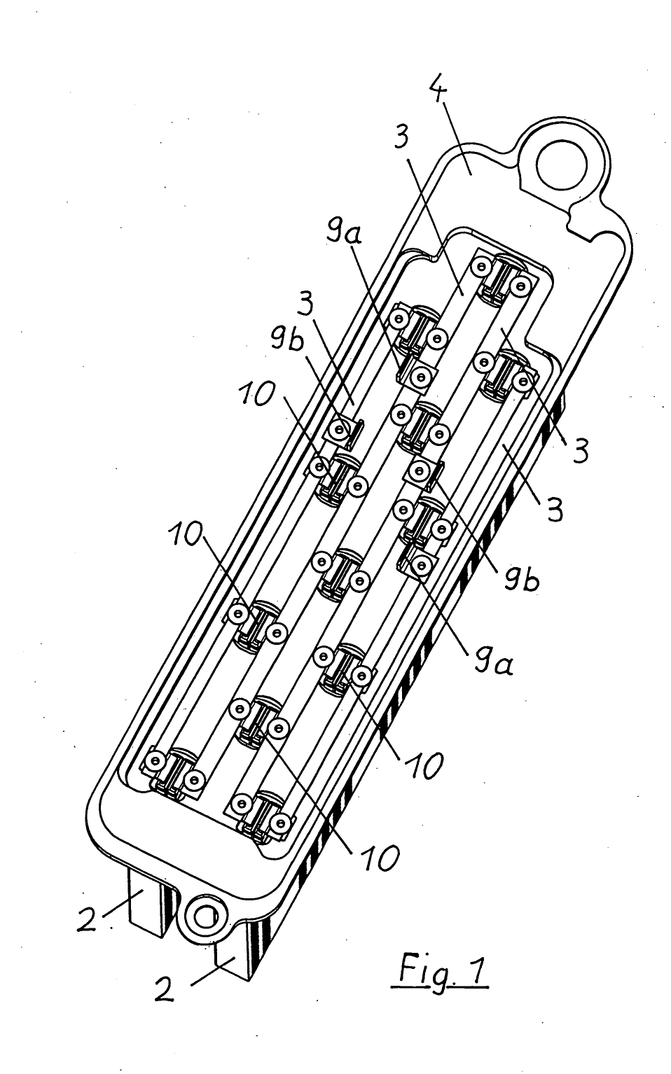

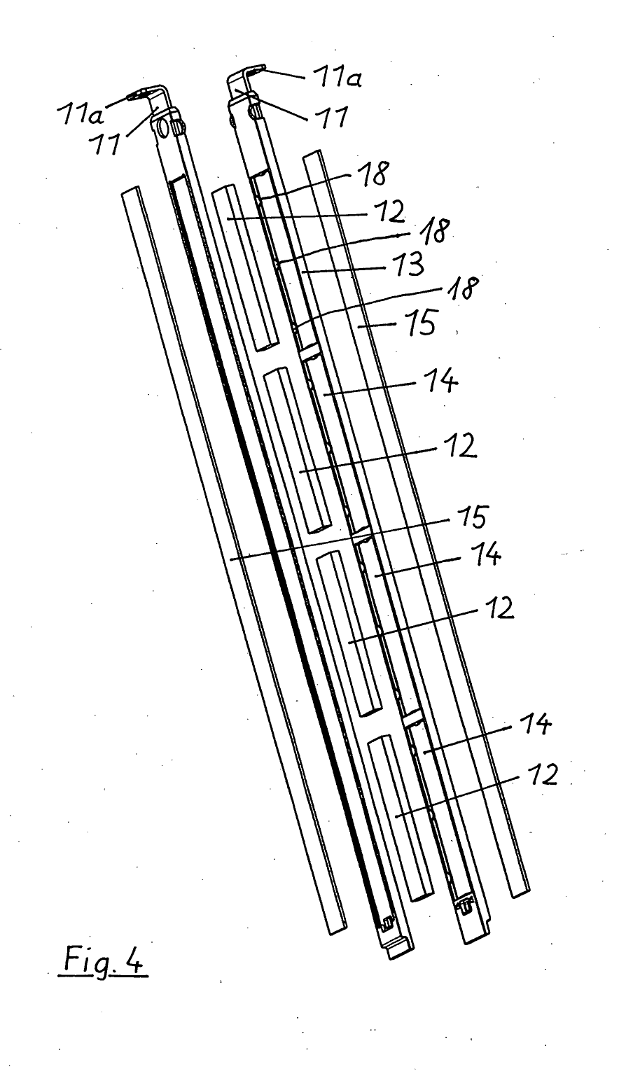

FIG. 1 shows an embodiment of a vehicle heating system 1 comprising a plurality of heat transfer devices 2 through which an air flow to be heated can flow and which are arranged in series as seen in flow direction. The heat transfer devices 2 are provided with heating device receptacles with openings into which heating devices 10 are inserted. The structure of said heating devices 10 is shown in FIG. 4. The heating devices 10 are connected to contact rails 3 which extend perpendicular to the flow direction and are to be alternately connected to the poles of a voltage source. The heat transfer devices 2 with the heating devices 10 attached thereto are connected to form an assembly, this being achieved by means of a holder 4 which is placed on their front side.

The holder 4 can, for example, be made of plastic or metal, in particular of aluminum. In the exemplary embodiment shown, the holder 4 is made of metal and can therefore advantageously be used for electrically grounding the heat transfer devices 2. Preferably, the holder 4 is connected to the heat transfer devices 2 in a clamping manner. As an alternative or in addition, it is also possible to attach the heat transfer devices 2 to the holder 4 in a positive manner, for example by screwing or snapping into place.

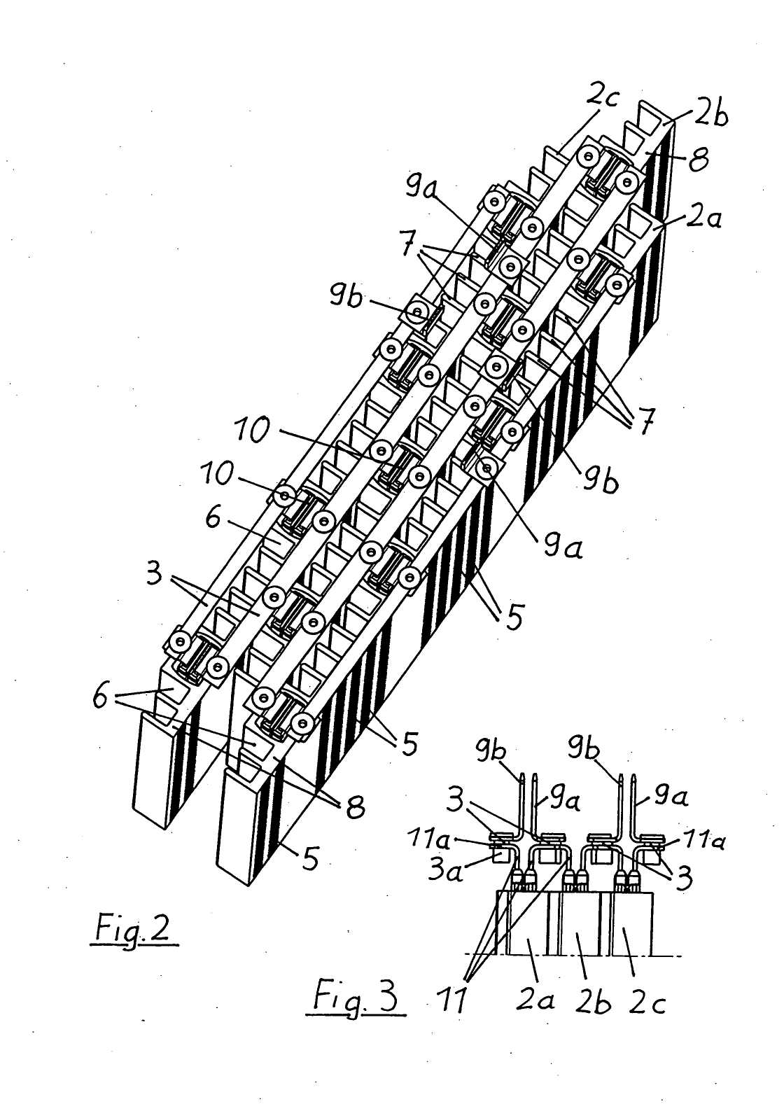

FIG. 2 shows the vehicle heating system shown in FIG. 1 without the holder. As can be seen from FIG. 2, the vehicle heating system comprises three identical heat transfer devices 2a, 2b, 2c, which are arranged in series as seen in flow direction. Therein, neighboring heat transfer devices 2a, 2b, 2c are arranged in a staggered manner transverse to the flow direction. This is to advantage in that the heating devices 10 of neighboring heat transfer devices 2a, 2b, 2c are also arranged in a staggered manner with respect to the flow direction, this resulting in an enhanced heat output to the air flow.

In the embodiment shown, the heat transfer devices 2a, 2b, 2c are extruded profiles which have holes 5 through which air can flow transverse to the direction of extrusion. In the embodiment shown, these holes 5 are only shown schematically by means of strip-like sections of the extruded profile. A plurality of holes 5 is arranged in the strip-like sections. For example, the holes 5 can be punched into the extruded profile and can be of almost any shape desired. Circular or slotted holes are particularly suitable.

The extruded profiles 2a, 2b, 2c each comprise a plurality of tubes 6, into which the heating devices 10 are inserted. The tubes 6 or the openings of these rectangular tubes 6, thus, form receptacles for the heating devices 10.

The extruded profiles 2a, 2b, 2c have heat transfer fins 7 which extend from a base plate 8. The holes 5 through which air to be heated can flow are provided in said base plate 8. In the embodiment shown, heat transfer fins 7 each extend from only one side of this plate 8. However, it is also possible that heat transfer fins 7 extend from both sides of the plate 8.

FIG. 3 shows a detail of a lateral view of FIG. 2 as seen perpendicular in relation to the flow direction and perpendicular in relation to the extrusion direction of the heat transfer devices 2a, 2b, 2c. The aforementioned contact rails 3 can be recognized more clearly in FIGS. 1 and 2. Apart from the contact rails 3 which are the foremost as seen in flow direction and the backmost as seen in flow direction, each contact rail 3 is connected to heating devices 10 of two neighboring heat exchangers 2a, 2b, 2c. Electric connectors 9a, 9b are attached to the contact rails 3. The connectors 9a are for connection to the negative pole and the connectors 9b to the positive pole of a voltage source. Then electric current flows through heating devices 10 of neighboring heat exchangers 2a, 2b, 2c in opposite direction.

The structure of the heating devices 10 can be seen from FIG. 4. The heating devices 10 each have two equal contact plates 11, between which a plurality of rectangular heating elements 12 made of PTC ceramic (positive temperature coefficient) is arranged. The contact plates 11 each carry a positioning frame 13 which defines receptacles 14 for the heating elements 12. The positioning frame 13 is, preferably, made of plastic and can be pushed onto the contact plates 11. The positioning frame 13 can, however, also be injection-molded around the contact plates 11. The positioning frame 13 has clamping noses 18 which are arranged on inner sides surrounding the receptacles 14 and lock the inserted heating elements in position in a clamping manner.

Advantageously, the contact plates 11, positioning frames 13 and heating elements 12 can be pre-assembled to form a unit which can be easily handled.

As can be seen from FIG. 4, the positioning frame 13 leaves a rear side of the contact plates 11 open in the exemplary embodiment shown, said rear side facing away from the heating elements 12. On their side facing away from the heating elements 12, the contact plates 11 carry an electrically insulating lining which, in the exemplary embodiment shown, is made of a strip of a ceramic material, for example of aluminum oxide. Pre-assembled heating devices 10 can be wrapped with a plastic film, for example Kapton film. If use is made of an insulation strip 15, an additional electric insulation can be created in this manner. It is also possible to do without an insulation strip if a film is used. A film wrapped around can hold the components of the heating device 10 together, with the result that the latter can be pre-assembled and handled more easily.

The ends 11a of the contact plates 11 are connected to the contact rails 3 and are bent off. These ends 11a can, for example, be attached to the contact rails 3 by means of rivets 3a or screws.

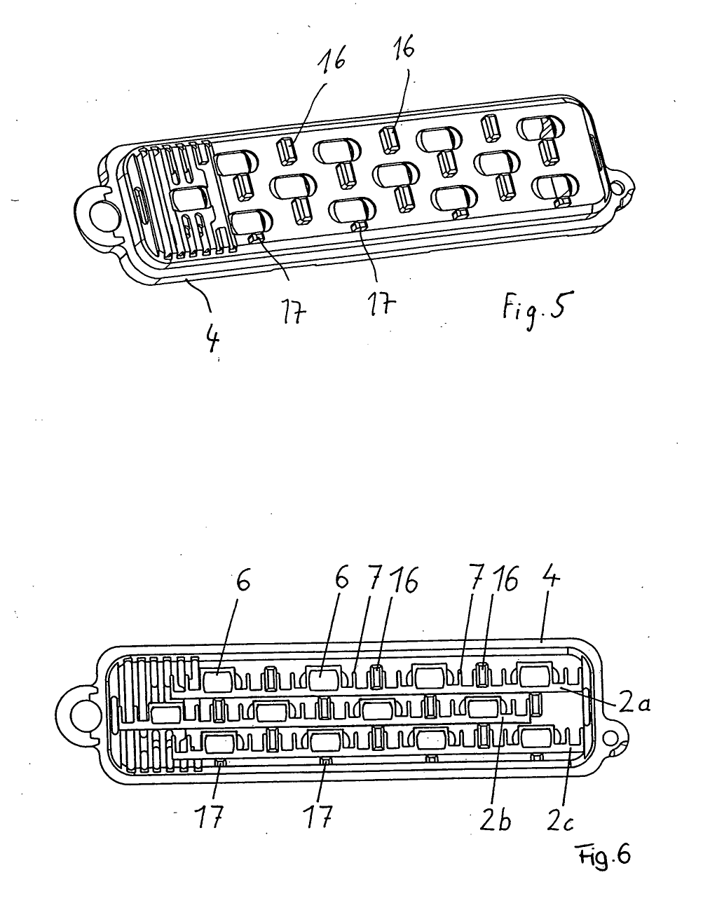

FIGS. 5 and 6 show the holder 4 from below, with its bottom side facing the heat transfer devices 2a, 2b, 2c in the assembled state. FIG. 5 shows the holder 4 without heat transfer devices 2a, 2b, 2c; FIG. 6 with heat transfer devices 2a, 2b, 2c. The holder 4 is connected to the heat transfer devices 2a, 2b, 2c in a clamping manner. To achieve this, the holder 4 is provided with positioning and clamping elements 16, 17, between which the heat transfer devices 2a, 2b, 2c are held in a friction-locked manner. The positioning and clamping elements 16, 17 are arranged on the bottom side of the holder 4 in a plurality of rows. These rows extend in transverse direction in relation to the flow direction and are arranged in a staggered manner in relation to each other. That means that a heat transfer device 2a, 2b, 2c is clamped between two rows of positioning and clamping elements 16, 17. Therein, an element 16, 17 of the one row is opposed by a gap between elements 16, 17 of the other row. The clamping elements 16 engage between the heat transfer fins 7. In the exemplary embodiment shown, the clamping elements 16 are approximately formed as rectangular pegs or ribs which are clamped between neighboring heat transfer fins 7. At the same time, the clamping elements 16 serve as a stop for the neighboring heat transfer device 2a or 2b, respectively. The elements 17 can also have a clamping function or only serve as stops for positioning the heat transfer devices 2a, 2b, 2c.

### REFERENCE SYMBOLS

1 Vehicle heating system

2a Heat transfer device

2b Heat transfer device

2c Heat transfer device

3 Contact rail

3a Rivet

4 Holder

5 Hole

6 Tube

7 Heat transfer fin

8 Plate

9a Connectors

9b Connectors

10 Heating device

11 Contact plate

11a Bent-off end of the contact plates

12 Heating elements

13 Positioning frame

14 Receptacle for heating elements

15 Insulating lining

16, 17 Positioning and clamping elements

18 Clamping noses

What is claimed is:

1. A vehicle heating system, comprising:
a plurality of heating devices each comprising at least one heating element arranged between two contact plates,
a plurality of heat transfer devices through which air to be heated can flow and to each of which at least one of the heating devices is attached, and
a holder which combines the heat transfer devices and the heating devices attached thereto to form an assembly, wherein
the heat transfer devices each comprise at least one heating device receptacle in which one of the heating devices is arranged.

2. The vehicle heating system according to claim 1, wherein the heating device receptacle comprises an opening into which the heating device is inserted.

3. The vehicle heating system according to claim 1, wherein the heating devices of neighboring heat transfer devices are arranged in a staggered manner.

4. The vehicle heating system according to claim 1, wherein the heat transfer devices are arranged in series as seen in flow direction.

5. The vehicle heating system according to claim 1, wherein the contact plates of the heating devices each carry a positioning frame which forms at least one receptacle for a heating element.

6. The vehicle heating system according to claim 1, wherein the positioning frames carry clamping noses for clamping the heating elements.

7. The vehicle heating system according to claim 1, wherein the contact plates and the positioning frames attached thereto are each shaped in an equal manner.

8. The vehicle heating system according to claim 1, wherein the holder holds the heat transfer devices in a clamping manner.

9. The vehicle heating system according to claim 1, wherein both contact plates of each heating device are electrically isolated from the heat transfer devices.

10. The vehicle heating system according to claim 1, wherein both contact plates of each heating device carry an electrically isolating lining on their side facing away from the at least one heating element.

11. The vehicle heating system according to claim 1, wherein the heating device receptacles are formed as tubes into which the heating devices are inserted.

12. The vehicle heating system according to claim 1, wherein the heat transfer devices are extruded profiles which have heat transfer fins.

13. The vehicle heating system according to claim 12, wherein the extruded profiles have holes through which air can flow in transverse direction in relation to the extrusion direction.

14. The vehicle heating system according to claim 13, wherein the holder comprises clamping elements which engage between the heat transfer fins.

15. The vehicle heating system according to claim 1, wherein the heat transfer devices each comprise a plurality of heating device receptacles.

16. The vehicle heating system according to claim 15, wherein a plurality of contact rails extend in parallel perpendicular to the flow direction, wherein the contact plates of the heating devices are each connected to one of two neighboring contact rails.

17. The vehicle heating system according to claim 16, wherein at least one of the contact rails is connected to contact plates of at least two of the heating devices which are positioned in heating device receptacles of neighboring heat transfer devices, one of said neighboring heat transfer devices being arranged down-stream of the other.

18. The vehicle heating system according to claim 1, wherein the heat transfer devices are shaped in an equal manner.

19. The vehicle heating system according to claim 18, wherein neighboring heat transfer devices are arranged in a different manner with respect to the flow direction.

20. The vehicle heating system according to claim 1, wherein the heating device receptacles are friction-locked in the holder.
